(19) United States
(12) Patent Application Publication
(10) Pub. No.: US 2006/0277607 A1
(43) Pub. Date: Dec. 7, 2006

(54) Authenticating method and apparatus

(76) Inventor: Hyun-Kwon Chung, Seoul (KR)

Correspondence Address: STEIN, MCEWEN & BUI, LLP, 1400 EYE STREET, NW, SUITE 300, WASHINGTON, DC, 20005, US

(21) Appl. No.: 10/554,847

(22) PCT Filed: Apr. 30, 2004
(86) PCT No.: PCT/KR04/01008

§ 371 Date: Oct. 28, 2005

(30) Foreign Application Priority Data
May 1, 2003 (KR) 10-2003-0028039
Sep. 23, 2003 (KR) 10-2003-0066023

(51) Int. Cl. H04L 9/32

(52) U.S. Cl. 726/27

(57) ABSTRACT

A reproducing apparatus and method are provided to reproduce an interactive content requiring authentication from a recording medium such as a disc or a remote server, via the Internet. An authenticating method employed at a remote server includes: (a) transmitting program codes for performing authentication to a reproducing apparatus in response to a request of content requiring the authentication from the reproducing apparatus; (b) receiving identification information for the authentication, which is transmitted as a result of executing the program codes in the reproducing apparatus, from the reproducing apparatus and performing the authentication; and (c) if the authentication is successful, transmitting the requested content to the reproducing apparatus, and if the authentication is not successful, transmitting a message notifying the authentication failure to the reproducing apparatus. As a result, only a function of reading data recorded on a disc according to a disc type is required without supporting a new method for disc authentication required by a content provider whenever a disc with a new format is produced or whenever a content format is developed. A reproducing apparatus can download a desired content from various servers after authentication without having to support various authenticating methods.

### CROSS-REFERENCE TO RELATED APPLICATIONS

This application claims the benefit of PCT International Patent Application No. PCT/KR2004/001008, filed Apr. 30, 2004, Korean Patent Application No. 2003-28039, filed May 1, 2003, in the Korean Intellectual Property Office, and Korean Patent Application No. 2003-66023, filed Sep. 23, 2003, in the Korean Intellectual Property Office, the disclosures of which are incorporated by reference herein.

### BACKGROUND OF THE INVENTION

1. Field of the Invention

The present invention relates to an apparatus and method for reproducing interactive contents produced using a markup language, and more particularly, to a reproducing apparatus and method for downloading or reading interactive contents from a recording medium such as a disc, or via a network such as the Internet.

2. Related Art

Conventional information for identifying contents recorded on a recording medium such as a disc (e.g., CD, CD-R, CD-RW, DVD, DVD+R/RW, and DVD-R/RW) or via an Internet server is not particularly defined. Therefore, in a conventional authenticating method, a reproducing apparatus (i.e., a disc player) authenticates a disc as an authorized copy by directly identifying the disc. That is, contents recorded on a CD are identified by a track running time and the number of tracks, contents recorded on a DVD-VIDEO are identified by the number of titles, the number of chapters, and reproducing times of the titles, and contents recorded on a DVD-AUDIO are identified by the number of albums, the number of groups, the number of tracks, and track running time. Also, only after authentication of a server is successful, a predetermined content can be downloaded from the server.

However, according to the conventional authenticating method, whenever a content format is changed, a reproducing apparatus must recognize new identification information and authenticate discs on the basis of the identification information. However, different companies providing contents (for example, CDDB) utilize different content authentication methods to recognize new identification information and authenticate discs on the basic of the identication. As a result, it is nearly impossible for a reproducing apparatus to support all the content authentication methods.

Likewise, the same problem applies to contents existing on Internet servers. That is, to download predetermined contents from a plurality of servers, via the Internet, employing different authenticating methods, a reproducing apparatus must also support different authenticating methods employed by the different servers, via the Internet.

### SUMMARY OF THE INVENTION

Various aspects and embodiments of the present invention advantageously provide an authenticating method for a reproducing apparatus, which can be used when a predetermined content is read from a disc or downloaded from an Internet server which uses a plurality of authentication methods.

The present invention also provides a method of performing an authentication by using an encrypting/decrypting algorithm determined by a server on the Internet when a predetermined content is requested as an encrypting/decrypting algorithm for the authentication and not defining the encrypting/decrypting algorithm used for the authentication in advance when a reproducing apparatus reading or downloading contents from a disc or an Internet server requests the predetermined content from the Internet server.

According to an aspect of the present invention, there is provided an authenticating method comprising: (a) transmitting program codes for performing authentication to a reproducing apparatus in response to a request of content requiring authentication from the reproducing apparatus; (b) receiving identification (ID) information for authentication, which is transmitted as a result of executing the program codes in the reproducing apparatus, from the reproducing apparatus, and performing the authentication; and (c) if the authentication is not successful, transmitting a requested content to the reproducing apparatus, and if the authentication is not successful, transmitting a message notifying an authentication failure to the reproducing apparatus.

It is preferable that step (a) comprises transmitting an authentication markup document as the program codes, and particularly, transmitting the program codes using an HTTP error code such as an HTTP error code 401 along with an authentication markup document.

According to another aspect of the present invention, there is provided an authenticating method comprising: (a) transmitting identification (ID) information for authentication to a server, via a network, after executing program codes received from the server; and (c) if the authentication is successful, receiving a requested content from the server, and if the authentication is not successful, receiving a message notifying an authentication failure from the server.

It is preferable that step (a) comprises extracting predetermined information including a type of a disc and a pattern of content recorded on the disc, from the disc, after executing the program codes and transmitting the extracted information to the server, via a network.

According to another aspect of the present invention, a reproducing apparatus comprises: a reader to read data from a disc; a buffer to store the data read from the reader; and a controller for controlling the reader to read data from the disc, the controller including a presentation engine to provide a user interface and access to a server, via a network, wherein the presentation engine transmits identification information for authentication to the server, via the network, by executing program codes received from the server, and if the authentication is successful, receives a requested content from the server, via the network, for a visual display on a screen, and if the authentication is not successful, receives a message notifying an authentication failure from the server, via the network, for a visual display on the screen.

It is preferable that the presentation engine extracts predetermined information including a type of a disc and a pattern of content recorded on the disc, from the disc, after executing the program codes and transmits the extracted information to the server, via the network and particularly, supports an API for executing an authentication markup document as the program codes.

According to yet another aspect of the present invention, an authenticating method in a server comprises: receiving a content request and a content ID of a desired content from a reproducing apparatus, via a network; generating an index number; encrypting authentication question information corresponding to the index number using an encryption key corresponding to the content ID; transmitting predetermined authentication data including the encrypted authentication question information and the index number to the reproducing apparatus, via the network; and receiving authentication answer information that is a result of a predetermined decryption and the index number from the reproducing apparatus, and performing the authentication.

According to yet another aspect of the present invention, an authenticating method in a reproducing apparatus comprises: requesting a desired content from a server and transmitting a content ID of the desired content to the server, via a network; receiving predetermined authentication data including encrypted authentication question information and an index number from the server, via the network; generating a decryption key by applying a one way function to a title key corresponding to the content ID and the index number; generating authentication answer information by decrypting the encrypted authentication question information using the decryption key; and transmitting the authentication answer information and the index number to the server, via the network.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a conceptual diagram of an authenticating process according to an embodiment of the present invention;

FIG. 2 is a block diagram of an example reproducing apparatus according to an embodiment of the present invention;

FIG. 3 is a reference diagram for illustrating an authenticating process using images on a displayer according to an embodiment of the present invention;

FIG. 4 is a flowchart of an authenticating method according to an embodiment of the present invention;

FIG. 5 is a conceptual diagram of an authenticating process according to another embodiment of the present invention; and

FIG. 6 is a flowchart of an authenticating method according to another embodiment of the present invention.

### DETAILED DESCRIPTION OF THE EMBODIMENTS

The present invention is applicable for use with all types of computer-readable media, reproducing apparatuses, computer systems implemented methods described according to various embodiments of the present invention, contents available in many well-known document mark-up languages such as, for example, hypertext mark-up language (HTML) and extensible HTML (XML) transmitted via networks and transmission protocols, such as hypertext transfer protocol (HTTP) (as defined by RFC 2616), used for transfer such contents between interconnected systems in such networks. Reference will now be made in detail to the various aspects and embodiments of the present invention, examples of which are illustrated in the accompanying drawings, wherein like reference numerals refer to the like elements throughout. The various aspects and embodiments are described below in order to explain the present invention by referring to the figures.

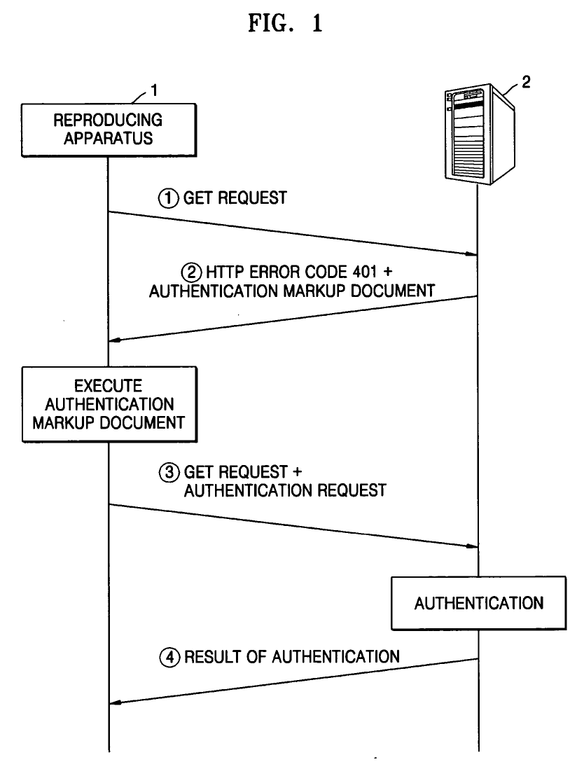

Turning now to FIG. 1, a conceptual diagram of an authenticating process between an example reproducing apparatus and an Internet server according to an embodiment of the present invention is illustrated. Referring to FIG. 1, a reproducing apparatus 1 requests a predetermined content from a server 2, via the Internet, by transmitting a GET request based on an HTTP protocol (RFC2616) in step \textcircled{1}. If the reproducing apparatus 1 has not gotten a required authentication, the server 2 transmits an authentication markup document for the authentication along with an HTTP error code 401 to the reproducing apparatus 1, via the Internet, in step \textcircled{2}. A complete listing of HTTP error codes can be found pursuant to Internet RFC 2616. For example, a HTTP error code 401 represents an error message indicating that authorization has been refused and authentication is required. The reproducing apparatus 1 executes the received authentication markup document. The authentication markup document is a computer program installed and executed in the reproducing apparatus 1 for performing an authenticating process. In accordance with various embodiments of the present embodiment, the authentication markup document includes Javascript codes for authentication. As a result of executing the authentication markup document, identification information required for the authentication is generated, and the generated identification information is transmitted to the server 2, via the Internet, along with the GET request in step \textcircled{3}. The server 2 performs the authentication, i.e., authenticate a user at the reproducing apparatus 1 before granting access to a desired content, by checking the received identification information, and transmits the authentication result to the reproducing apparatus 1, via the Internet, in step \textcircled{4}.

In step \textcircled{1}, the following example HTTP header is transmitted from the reproducing apparatus 1 to the server 2, via the Internet:

GET/propriatematerial.cgi HTTP/1.0

Date: Fri, 20 Sep. 1996 08:20:58 GMT

Connection: Keep-Alive

User-Agent: ENAV 1.0(SDP-100).

In step \textcircled{2}, an HTTP header and an authentication markup document are transmitted from the server 2 to the reproducing apparatus 1, via the Internet. Here, a server authentication request number can be included using a cookie to prevent the reproducing apparatus 1 from being emulated as if the reproducing apparatus 1 got the authentication.

The example HTTP header is as follows:

HTTP/1.0 401 Unauthorized

Date: Fri, 20 Sep. 1996 08:20:58 GMT

Server: ENAV 1.0(NCSA/1.5.2)

Last-modified: Fri, 20 Sep. 1996 08:17:58 GMT

Content-type: text/xml+html

Content-length: 200

Set-Cookie: server_req=“12345098761234509876”; Version=“1”; Path=“/”

The example authentication markup document is as follows:

<html>
<head>
<title>Authentication is required</title>
</head>
<body>
<object data=” dvd://video_ts/video_ts.ifo” id=” player” />
<script src=” cookieutil.js” language=” Javascript” />
<script language=” Javascript” />
seed = 100123;
setCookie( “hashkey” ,player.getHashKey(seed);
setCookie( “authoringtype” ,player.authoringType);
setCookie( “disctype” ,player.discType);
location.herf = “propriatematerial.cgi” ;
</script>
</body>
</html>

In step \textcircled{3}, the following example HTTP header is transmitted from the reproducing apparatus 1 to the server 2, via the Internet:

GET/propriatematerial.cgi HTTP/1.0

Date: Fri, 20 Sep. 1996 08:20:58 GMT

Connection: Keep-Alive

User-Agent: ENAV 1.0(SDP-100)

Cookie:$Version=“1”;

server_req=“12345098761234509876”; $Path=“/”

hashkey=“123AB1234”; $Path=“/”

disctype=“1”; $Path=“/”

In step \textcircled{4}, an HTTP header and a markup document notifying an authentication success or an authentication failure are transmitted from the server 2 to the reproducing apparatus 1, via the Internet. Here, the server 2 can insert an access identifier verifying authentication in a next access in the HTTP header using the cookie, and transmit the HTTP header including the access identifier to the reproducing apparatus 1.

The example HTTP header is as follows:

HTTP/1.0 200 Forbidden

Date: Fri, 20 Sep. 1996 08:20:58 GMT

Server: ENAV 1.0(NCSA/1.5.2)

Last-modified: Fri, 20 Sep. 1996 08:17:58 GMT

Content-type: text/xml+html

Content-length: 83

Set-Cookie: server_req=“12345098761234509876”; Version=“1”; Path=“/”

The example markup document notifying the authentication failure is as follows:

<html>
<head>
<title>Access denied</title>
</head>
<body>
The access is denied because of using illegal disc.
</body>
</html>

The example markup document notifying the authentication success is as follows:

<html>
<head>
<title>Access accepted</title>
</head>
<body>
The access is accepted because of using legal disc.
</body>
</html>

As described above, according to the present invention, the authentication markup document for performing only the authentication and not for being displayed on a screen is transmitted from the server 2 to the reproducing apparatus 1. When the HTTP protocol is used, it is preferable that the HTTP error code 401 is used. However, other transmission protocols and corresponding error codes can also be used.

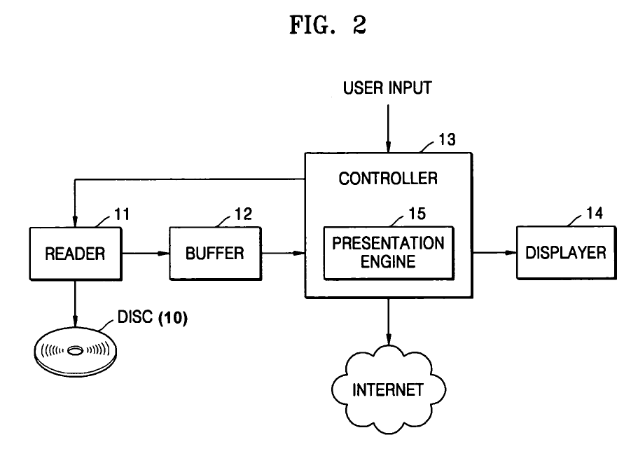

FIG. 2 is a block diagram of an example reproducing apparatus 1 according to an embodiment of the present invention.

Referring to FIG. 2, the reproducing apparatus 1 includes a disc 10, a reader 11, a buffer 12, a controller 13, and a displayer 14. A presentation engine 15 is included in the controller 13. The presentation engine 15 is connected to the server 2, via the Internet, and executes an authentication markup document downloaded from the server 2 for performing authentication according to the present invention. That is, the presentation engine 15 includes an analysis engine for analyzing the markup document and a script program included in the markup document, and a browser for downloading a predetermined content from the server 2 when connected to the server 2, via the Internet. Standard web browsers such as Microsoft Internet Explorer, Netscape Navigator can be incorporated into the presentation engine 15 to provide the user interface and to access the server 2, via the Internet.

The reader 11 reads contents recorded on a disc 10 and provides the contents to the buffer 12 for temporary storage, according to the controller 13. The buffer 12 buffers the contents provided from the reader 11, or the contents transmitted from the server 2 via the presentation engine 15. If the authentication is successful, the displayer 14 displays the contents transmitted from the server 2, and if the authentication is not successful, the displayer 14 displays a message notifying the authentication failure.

The presentation engine 15 supports the following example API for executing the authentication markup document. The API is used to extract identification information for authentication from the disc 10.

1. [obj].discType

1) contents:

indicate a disc type.

2) return value:

0=Compact Disc

1=DVD-ROM

2=DVD-R

3=DVD-RAM

4=DVD-RW

5=DVD+RW

2. [obj].authoring Type

1) contents:

indicate an authoring type.

2) return value:

0=CDDA

1=DVD-Video

2=DVD-Audio

3. [obj].getHashKey(seed)

1) contents:

read information on a disc 10 according to seed and a disc type.

2) parameter:

seed: CDDA—a time set by tracks of a TTHHMMSSFF pattern and partial value of a frame

DVD-Video—a 32-bit logical sector number and partial value intended to read in the sector

DVD-Audio—a 32-bit logical sector number and partial value intended to read in the sector

3) return value:

a value extracted at a directed position

CDDA—partial value of a frame

DVD-Video—partial value of data of a sector extracted from a logical sector number

DVD-Audio—partial value of data of a sector extracted from a logical sector number.

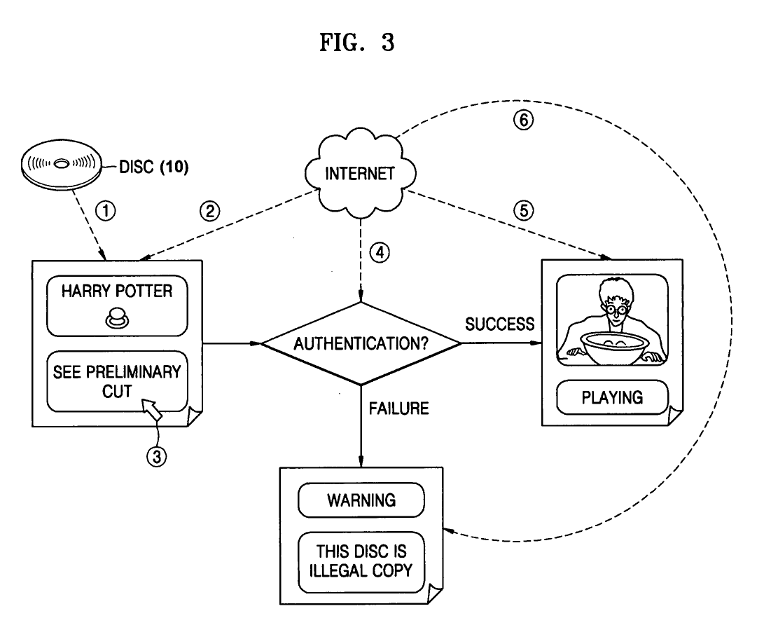

FIG. 3 is a reference diagram for illustrating an authentication process utilized by an example reproducing apparatus using images on the displayer according to an embodiment of the present invention.

Referring to FIG. 3, when a user uses a reproducing apparatus 1 to view either a predetermined content recorded on a disc 10 in step \textcircled{1}, or a predetermined content downloaded from the server 2, via the Internet in step \textcircled{2}, such a predetermined content is displayed on a screen of the displayer 14. If the user wants to view other content requiring authentication, a button displayed on a screen of the displayer 14 requesting a desired content can be pushed in step \textcircled{3}. A desired content requiring authentication can be recorded on a disc 10 or stored in a server 2. Upon receipt of the user's request, an authentication markup document for the authentication according to the present invention is transmitted from the server 2 to the reproducing apparatus 1, via the Internet in step \textcircled{4}. Authentication is performed at the reproducing apparatus 1 by processing the authentication markup document therein. The reproducing apparatus 1 then transmits identification information for authentication back to the server 2, via the Internet. If the authentication is successful, the user at the reproducing apparatus 1 is authorized to access the desired content, and the desired content is downloaded from the server 2, via the Internet, and displayed on the screen of the displayer 14 on the reproducing apparatus 1 in step \textcircled{5}. However, if the authentication is not successful, the user at the reproducing apparatus 1 is not authorized to access the desired content, and a message notifying the authentication failure is displayed on the screen of the displayer 14 on the reproducing apparatus in step \textcircled{6}. An example warning message such as “This disc is an illegal copy”, as shown in FIG. 3, can be displayed to notify such an authentication failure.

An authenticating method according to an embodiment of the present invention will now be described on the basis of the construction described above.

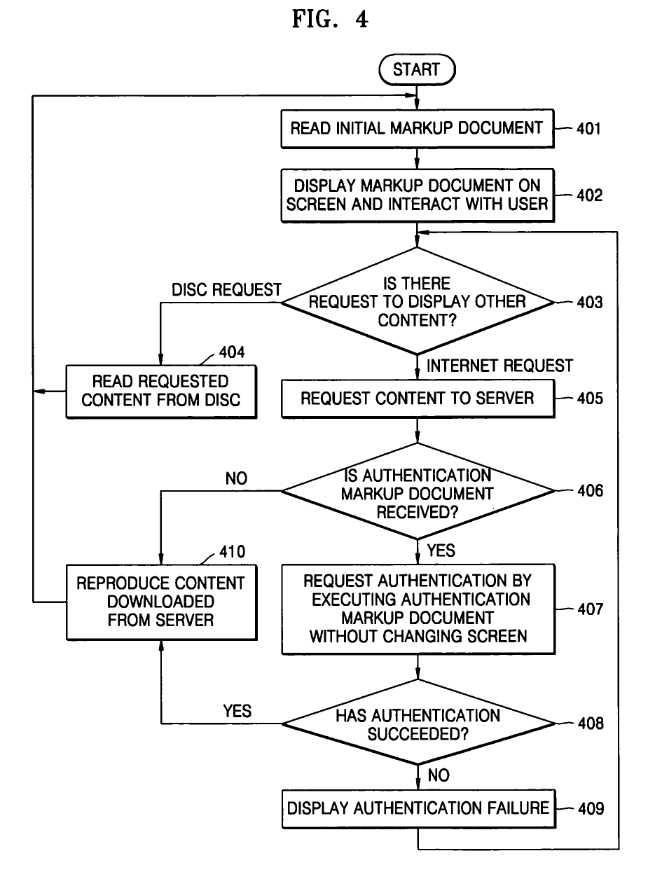

FIG. 4 is a flowchart of an authenticating method utilized by an example reproducing apparatus according to an embodiment of the present invention.

Referring to FIG. 4, a markup document designated as an initial document is read in step 401. The markup document is displayed on a screen of the displayer 14 on a reproducing apparatus 1, and interaction with a user is permitted with the displayed markup document in step 402. During the interaction, the reproducing apparatus 1 determines if the user requests to display other content in step 403. In this situation, the other content can be available from a disc 10, or alternatively, from a remote server 2, via the Internet. If the requested content is recorded on a disc 10, the requested content is read from the disc 10 in step 404. However, if the requested content is stored in the server 2, via the Internet, such a content is then requested from the server 2 in step 405. If authentication is required to access the content, the server 2 transmits an authentication markup document to the reproducing apparatus 1 for authentication. However, if authentication is not required, the requested content can be accessed and downloaded directly from the server 2, via the Internet.

Therefore, upon making a request for content at the server 2, the reproducing apparatus 1 determines if an authentication markup document is received from the server 1 in step 406. If an authentication markup document is received from the server 2 indicating that authentication is required before the requested content can be accessed and downloaded from the server 2, the reproducing apparatus 1 requests the authentication from the server 2 by executing the authentication markup document without displaying the authentication markup document on a screen of the displayer 14, as shown in FIG. 2, in step 407. If the authentication is not successful in step 408, the reproducing apparatus 1 provides a visual display of a message notifying the authentication failure on the screen of the displayer 14 in step 409. However, if the authentication is successful, the server 2 downloads the content to the reproducing apparatus 1, and the reproducing apparatus 1 reproduces the downloaded content in step 410.

Referring back to step 406, if an authentication markup document is not received from the server 2, the requested content is accessible without the authentication, and the server 2 directly downloads the requested content to the reproducing apparatus 1 without transmitting the authentication markup document. The reproducing apparatus 1 reproduces the content downloaded directly from the server 2, via the Internet, in step 410.

Hereinafter, the specific of authentication in a case where there is a content request from the reproducing apparatus 1 to the server 2 in step 405 of FIG. 4 will now be described.

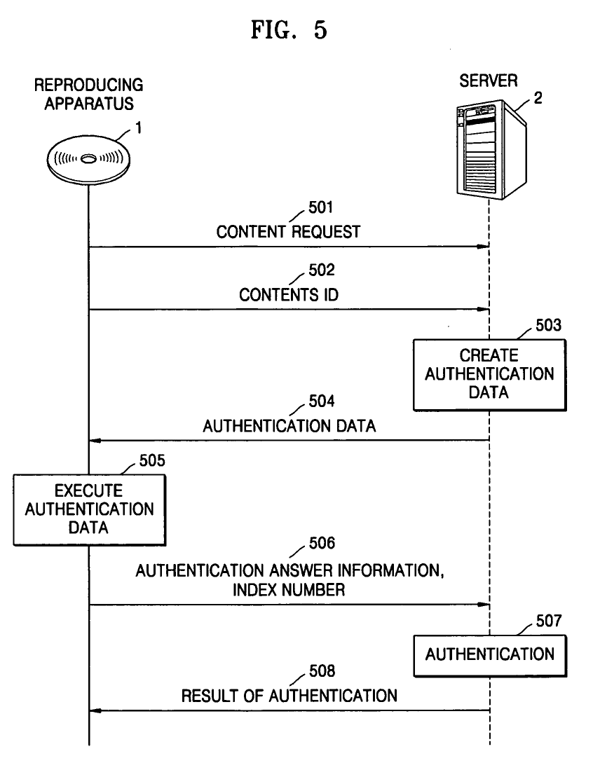

FIG. 5 is a conceptual diagram of an authenticating process according to another embodiment of the present invention.

Referring to FIG. 5, an authenticating method is achieved through data exchange between the reproducing apparatus 1 and the server 2, via the Internet. The reproducing apparatus 1 reproduces a desired content by reading or downloading the interactive content from a disc 10 or a remote server 2, via the Internet. To do this, the reproducing apparatus 1 includes a reader 11 for reading content from a disc 10, a buffer 12 for buffering the content read by the reader 11, a controller 13 for controlling the reader 11 to read the content from the disc 10 or the remote server 2, via the Internet, and for performing an authenticating process, in which a presentation engine 15 is activated to provide a visual display of the read content on a screen of the displayer 14, as shown in FIG. 2.

When a desired content is requested to be downloaded over the Internet due to the absence of such a content on a disc 10, the reproducing apparatus 1 transmits a content request to the server 2, via the Internet, in step 501. At this time, a content ID of a desired content is transmitted together with the content request in step 502.

Upon receipt of the content request and the content ID from the reproducing apparatus 1, the server 2 creates authentication data in step 503. The server 2 then transmits the authentication data to the reproducing apparatus 1 in step 504. Such authentication data includes encrypted authentication question information, an index number, and a decrypting method for authentication. The reproducing apparatus 1 processes the authentication data, including performing a decryption for authentication using the authentication data in step 505. The reproducing apparatus 1 then transmits authentication answer information that is a result of the decryption and the index number to the server 2 in step 506. The server 2 can transmit data representing a decrypting method to be performed by the reproducing apparatus 1 for authentication, or program codes for the decryption (i.e., authentication algorithms).

The program codes can be formed with a type to be directly performed in the reproducing apparatus 1 or a markup document. The markup document is the general term for documents written in a markup language, such as HTML and XML, and documents where source codes written in a script language or a Java language are linked or inserted, and it is also used to include all files linked to the markup document.

In order to confirm what a program type to be performed in the reproducing apparatus 1, data exchange between the server 2 and the reproducing apparatus 1 can be additionally performed. Since the program is executed in the controller 13, the reproducing apparatus 1 informs the server 2 of what kind of types the controller 13 can analyze.

The authentication answer information is a result generated by executing the authentication data transmitted from the server 2. The server 2 receives the authentication answer information from the reproducing apparatus 1 and performs authentication of the user at the reproducing apparatus 1 based on the authentication answer information in step 507. The authentication answer information includes a result of decrypting the encrypted authentication question information, and the server 2 compares the authentication answer information received from the reproducing apparatus 1 and the authentication question information corresponding to the index number received from the reproducing apparatus 1 among a plurality of stored authentication question information and confirms whether they are the same. The server 2 completes the authentication of the requested content by transmitting a result of the authentication to the reproducing apparatus 1 in step 508.

If the authentication is successful, the server 2 transmits a message notifying the authentication success followed by the content requested by the reproducing apparatus 1 to the reproducing apparatus 1, and the reproducing apparatus 1 reproduces the requested content for a visual display on a screen of the displayer 14.

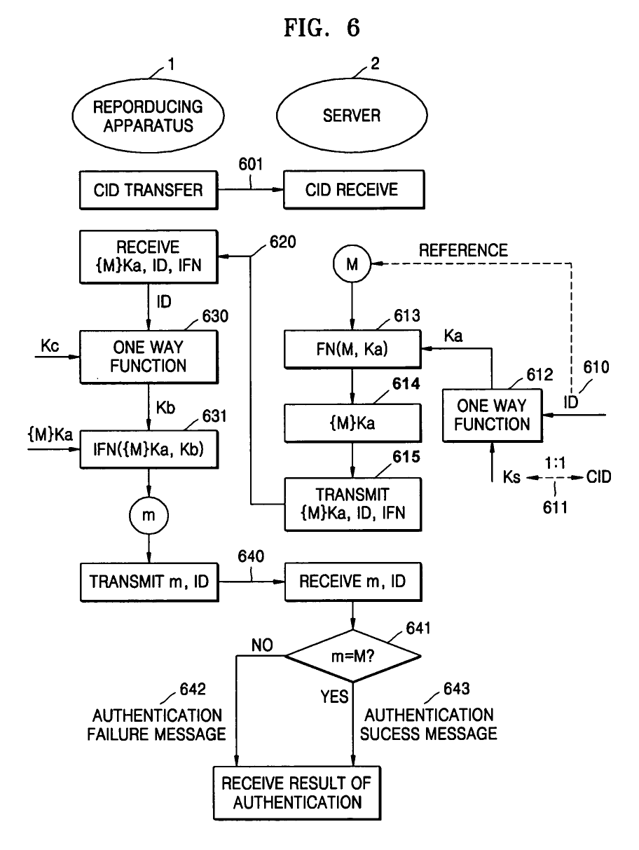

FIG. 6 is a flowchart of an authenticating method according to another embodiment of the present invention.

Referring to FIG. 6, a process of generating authentication data in the server 2 and generating authentication answer information in the reproducing apparatus 1 using the authentication data is described in detail herein below.

The server 2 receives a content ID (CID) from the reproducing apparatus 1 in step 601, and generates an index number (ID) in step 610. The index number (ID), which is a symbol corresponding to authentication question information (M), is used to search the authentication question information (M) when authentication data is generated in order to compare authentication answer information (m) received from the reproducing apparatus 1 and the authentication question information (M). The index number (ID), which is one of numbers of authentication question information stored in the server 2, can be designated sequentially or randomly in response to each content request.

The server 2 generates an encryption key (Ka) by applying a one way function to a title key (Ks) and the index number (ID) corresponding to the content ID (CID) requested by the reproducing apparatus 1 in step 612. The title key (Ks) uniquely corresponds to the content ID (CID) in step 611. The title key (Ks) is information that the server 2 and the reproducing apparatus 1 must have. The one way function means that there exists a normal function, but not its inverse function. That is, the encryption key (Ka) can be generated from the title key (Ks) and the index number (ID) using the one way function; however, the title key (Ks) cannot be extracted from the encryption key (Ka) and the index number (ID).

Comparing the authenticating method of the present embodiment shown in FIG. 6 and a conventional authenticating method using a username and password, it can be seen that the content ID (CID) corresponds to the username and the title key (Ks) corresponds to the password. A characteristic of the authenticating method of the present embodiment is that the title key (Ks) corresponding to the password is not transmitted over the Internet. As information transmitted over the Internet, the index number (ID), the authentication question information (M), and the authentication answer information (m) are included. The index number (ID), the authentication question information (M) and the authentication answer information (m) are generated using the title key (Ks) and have different values whenever authentication is performed. As a result, even if an unauthorized user happens to know several authentication question information and authentication answer information corresponding to the authentication question information, a title key (Ks) corresponding to a content ID (CID) is kept secret, and the unauthorized user cannot obtain an approval in response to a content request.

A portion of information of the requested content or certain data can be used as the authentication question information (M). Also, known techniques can be implemented to prevent an unauthorized user from seeking authentication by using a very long character stream.

The server 2 encrypts the authentication question information (M) using the encryption key (Ka) in step 613, and generates encrypted authentication question information ({M}Ka) in step 614. The server 2 then transmits the encrypted authentication question information ({M}Ka), the index number (ID), and information of a decryption function (IFN) to the reproducing apparatus 1, via the Internet, in step 615.

As the information of a decryption function (IFN), one of functions that can be executed by the reproducing apparatus 1 can be designated, or decryption program codes that can be executed by the reproducing apparatus 1 can be used as they are. As described above, since encrypting and decrypting methods used for authentication of a content request can be determined by a server when the authentication is performed and are not determined in advance when a reproducing apparatus is manufactured, the reproducing apparatus can support various authenticating methods.

The reproducing apparatus 1 receives the encrypted authentication question information ({M}Ka), the index number (ID), and the information of the decryption function (IFN) from the server 2, via the Internet, in step 620, and generates a decryption key (Kb) by applying a one way function to a title key (Kc) corresponding to the content ID (CID) and the index number (ID) in step 630. Similar the one way function used in the server 2, a function from which a title key (Kc) cannot be taken using a decryption key (Kb) and an index number (ID) is, used as the one way function used in the reproducing apparatus 1.

The reproducing apparatus 1 decrypts the encrypted authentication question information ({M}Ka) received from the server 2 using the generated decryption key (Kb) to generate authentication answer information (m) in step 631. If an authorized user requests the authentication using the reproducing apparatus 1, the authentication answer information (m) will be the same as the authentication question information (M) used in the server 2.

The reproducing apparatus 1 transmits the authentication answer information (m) and the index number (ID) to the server 2, via the Internet, in step 640. The server 2 compares authentication question information (M) corresponding to the index number (ID) and the authentication answer information (m) transmitted from the reproducing apparatus 1 in step 641. As a result of the comparison, if the authentication question information (M) and the authentication answer information (m) are the same, the server 2 approves the content request by transmitting an authentication success message, and transmits a desired content to the reproducing apparatus 1 in step 643, and if the authentication question information (M) and the authentication answer information (m) are not the same, the server 2 rejects the content request by transmitting an authentication failure message in step 642.

The authenticating method of the present embodiment can be modified and applied to the reproducing apparatus 1 and the server 2, when the reproducing apparatus 1 intends to authenticate whether the server 2 from which content is downloaded is authorized, or when the reproducing apparatus 1 intends to confirm whether a downloaded content is authorized. That is, the reproducing apparatus 1 generates predetermined authentication question information (M) and an index number (ID) corresponding to the predetermined authentication question information (M), performs each step performed by the server 2 as shown in FIG. 6, and transmits encrypted authentication question information (M), the index number (ID), and information indicating a decrypting method to the server 2. The server 2 performs each step performed by the reproducing apparatus 1 as shown in FIG. 6, and transmits authentication answer information and the index number (ID), which is a result of decryption, to the reproducing apparatus 1. The reproducing apparatus 1 can confirm whether the server 2 is authorized by comparing the authentication answer information received from the server 2 and the authentication question information corresponding to the index number.

The authenticating method described above can be written as computer programs. Codes and code segments for forming the computer programs can be easily construed by programmers skilled in the art to which the present invention pertains. The authenticating method is embodied by storing the computer programs on computer readable recording media, reading the computer programs using a computer, and executing the computer programs. The computer readable recording media include magnetic storage media, optical recording media, and storage media such as carrier waves.

As described above, according to the present invention, by adding only a function of reading data recorded on a disc according to a disc type without supporting a new method for disc authentication required by a content provider whenever a disc with a new format is produced or whenever content with a new format is developed, a reproducing apparatus can download a predetermined content from various servers supporting various authenticating methods and performing the authentication without supporting the various authenticating methods.

Accordingly, a user can determine whether a used disc 10 is an authorized copy or an illegal copy. Also, the content provider can receive financial benefits by providing the contents only to authorized users.

Furthermore, according to the present invention, since encrypting and decrypting methods used for authentication of a content request can be determined by a server when the authentication is performed and are not determined in advance when a reproducing apparatus is manufactured, the reproducing apparatus can support various authenticating methods. Also, since only a result of performing encryption by applying a one way function to a title key used as a password for authentication is transmitted over the Internet and the title key is not transmitted, it can be prevented for an unauthorized user to be authenticated.

While the present invention has been particularly shown and described with reference to exemplary embodiments thereof, it will be understood by those of ordinary skill in the art that various changes in form and details may be made therein without departing from the spirit and scope of the present invention. For example, a reproducing apparatus can also be a personal computer (PC), a personal digital assistant (PDA), a mobile phone or other wireless devices with wireless access to a remote server, via the Internet. A desired content requiring authentication can also be recorded and retrieved directly from a disc; however, authentication can still be required either from a remote server, via the Internet, or from the disc before full access can be granted. In addition, different authentication techniques and security algorithms can be employed as long as authentication as described in connection with FIG. 5 and FIG. 6 is achieved. Similarly, the system controller can be implemented as a chipset having firmware, or alternatively, a general or special purposed computer programmed to implement methods as described with reference to FIG. 1, FIG. 3, FIG. 4, FIG. 5 and FIG. 6. Accordingly, it is intended, therefore, that the present invention not be limited to the various example embodiments disclosed, but that the present invention includes all embodiments falling within the scope of the appended claims.

1. An authenticating method comprising:
(a) transmitting program codes for performing authentication to a reproducing apparatus in response to a request of content requiring authentication from the reproducing apparatus;
(b) receiving identification information for authentication, transmitted as a result of executing the program codes in the reproducing apparatus, from the reproducing apparatus, and performing the authentication; and
(c) if the authentication is successful, transmitting a requested content to the reproducing apparatus, and if the authentication is not successful, transmitting a message notifying an authentication failure to the reproducing apparatus.

2. The method as claimed in claim 1, wherein step (a) comprises transmitting an authentication markup document as the program codes.

3. The method as claimed in claim 1, wherein step (a) comprises transmitting an HTTP error code along with an authentication markup document, as the program codes.

4. An authenticating method comprising:
(a) transmitting identification information for authentication to a server, via a network, after executing program codes received from the server; and
(c) if the authentication is successful, receiving a requested content from the server, and if the authentication is not successful, receiving a message notifying an authentication failure from the server.

5. The method as claimed in claim 4, wherein step (a) comprises:
extracting predetermined information including a type of a disc and a pattern of content recorded on the disc, from the disc after executing the program codes and transmitting the extracted information to the server.

6. A reproducing apparatus comprising:
a reader to read data from a disc;
a buffer to store data read from the reader; and
a controller for controlling the reader to read data from the disc, the controller including a presentation engine to provide a user interface and access a server, via the Internet,
wherein the presentation engine transmits identification information for authentication to the server by executing program codes received from the server, and if the authentication is successful, receives a requested content from the server, via the Internet, for a visual display on a screen, and if the authentication is not successful, receives a message notifying an authentication failure from the server, via the Internet, for a visual display on the screen.

7. The apparatus as claimed in claim 6, wherein the presentation engine extracts predetermined information including a type of a disc and a pattern of content recorded on the disc from the disc after executing the program codes and transmits the extracted information to the server, via the Internet.

8. The apparatus as claimed in claim 6, wherein the presentation engine supports an API for executing an authentication markup document as the program codes.

9. An authenticating method in a server, comprising:
(a) receiving a content request and a content ID of a desired content from a reproducing apparatus, via a network;
(b) generating an index number;
(c) encrypting authentication question information corresponding to the index number using an encryption key corresponding to the content ID;
(d) transmitting predetermined authentication data including the encrypted authentication question information and the index number to the reproducing apparatus, via the network; and
(e) receiving authentication answer information that is a result of a predetermined decryption and the index number from the reproducing apparatus, and performing the authentication.

10. The method as claimed in claim 9, wherein step (c) comprises:
(c1) generating an encryption key by applying a one way function to a title key corresponding to the content ID and the index number; and
(c2) encrypting authentication question information corresponding to the index number using the encryption key.

11. The method as claimed in claim 9, wherein step (d) comprises:
transmitting the encrypted authentication question information, the index number, and information of a decryption function to be performed by the reproducing apparatus, to the reproducing apparatus.

12. The method as claimed in claim 9, wherein step (d) comprises:
transmitting the encrypted authentication question information, the index number, and decryption program codes to be performed by the reproducing apparatus, to the reproducing apparatus.

13. The method as claimed in claim 9, wherein step (e) comprises:
(e1) receiving the authentication answer information and the index number, which are a result of a predetermined decryption using the authentication question information and the index number, from the reproducing apparatus; and
(e2) comparing the authentication question information corresponding to the index number received from the reproducing apparatus and the authentication answer information, and if the authentication question information matches the authentication answer information, approving the content request, and if the authentication question information does not match the authentication answer information, rejecting the content request.

14. An authenticating method in a reproducing apparatus, the method comprising:
(a) transmitting a request for a desired content from a server and along with a content ID of the desired content to the server, via a network;
(b) receiving predetermined authentication data including encrypted authentication question information and an index number from the server, via the network;
(c) generating a decryption key by applying a one way function to a title key corresponding to the content ID and the index number;
(d) generating authentication answer information by decrypting the encrypted authentication question information using the decryption key; and
(e) transmitting the authentication answer information and the index number to the server, via the network.

15. The method as claimed in claim 14, wherein step (b) comprises:
receiving encrypted authentication question information, an index number, and a information of the decryption function to be performed in step (d) from the server, via the network.

16. The method as claimed in claim 14,
wherein step (b) comprises:
receiving encrypted authentication question information, an index number, and predetermined decryption program codes from the server, via the network, and
wherein step (d) comprises:
decrypting the encrypted authentication question information by executing the predetermined decryption program codes.

17. An apparatus, comprising:
a reader arranged to read an interactive content recorded on a recording medium; and
a presentation engine arranged to access to a remote server, via a network, and to provide a visual display of the interactive content from one of the recording medium and the remote server on a screen for user selection,
wherein, when a desired content selected by a user which requires authentication prior to access rights, the presentation engine requests authentication from the remote server, via the network, upon receipt of an authentication markup document from the remote server without displaying the authentication markup document on the screen, and if authentication is successful, receives the desired content from the remote server, via the Internet, for a visual display on the screen, and if the authentication is not successful, receives a message notifying an authentication failure from the remote server, via the Internet, for a visual display on the screen.

18. The apparatus as claimed in claim 17, wherein the presentation engine extracts ID information including a type of a recording medium and a pattern of contents recorded on the recording medium, from the recording medium after executing the authentication markup document, and transmits extracted ID information to the remote server, via the Internet, for authentication.

19. The apparatus as claimed in claim 17, wherein the presentation engine supports an API for extracting ID information for authentication from the recording medium.

20. The apparatus as claimed in claim 17, wherein, when the desired content is requested from the remote server, the presentation engine is configured to:
transmit a request for the desired content and a content ID of the desired content to the remote server, via the network;
decrypt authentication data received from the remote server, including encrypted authentication question information, an index number and information of a decryption function, and transmit authentication answer information and the index number as a result of decryption to the remote server, via the network, for authentication.

21. The apparatus as claimed in claim 17, wherein, when the desired content is requested from the remote server, the remote server is configured to:
receive a request for the desired content and a content ID of the desired content from the presentation engine, via the network;
generate an index number;
apply a one-way function to a title key corresponding to the content ID and the index number to generate an encryption key;
encrypt authentication question information using the encryption key; and
transmit encrypted authentication question information, the index number and information of a decryption function to the presentation engine, via the network.

22. The apparatus as claimed in claim 21, wherein, when the desired content is requested from the remote server, the presentation engine is configured to:
receive the encrypted authentication question information, the index number and information of a decryption function from the remote server, via the network;
apply a one-way function to a title key corresponding to the content ID and the index number to generate a decryption key;
decrypt the encrypted authentication question information using the decryption key; and
transmit authentication answer information and the index number to the remote server, via the network, for authentication with the authentication question information.

23. The apparatus as claimed in claim 22, wherein the access rights to the desired content are granted if the authentication question information matches with the authentication answer information.

24. The apparatus as claimed in claim 22, wherein the access rights to the desired content are denied if the authentication question information does not match with the authentication answer information.
